(19) United States
(12) Patent Application Publication
(10) Pub. No.: US 2025/0156875 A1
(43) Pub. Date: May 15, 2025

(54) System, Method, and Computer Program Product for Authorization Based on Predicted Settlement Position

(71) Applicant: Visa International Service Association, San Francisco, CA (US)

(72) Inventors: Austin Jones, Oakland, CA (US); Michael Mori, San Mateo, CA (US); Sheng Wang, Austin, TX (US)

(21) Appl. No.: 18/945,660

(22) Filed: Nov. 13, 2024

Related U.S. Application Data
(60) Provisional application No. 63/598,605, filed on Nov. 14, 2023.

(51) Int. Cl. G06Q 20/40

(52) U.S. Cl. CPC G06Q 20/4016

(57) ABSTRACT

Provided is a system, method, and computer program product for graph-based authorization. The system includes at least one processor programmed or configured to process a plurality of electronic payment transactions for a plurality of merchant systems arranged in an electronic payment processing network, generate a graph data structure including a plurality of nodes and a plurality of edges based on transaction data and external data, the transaction data including transaction parameters from each electronic payment transaction of the plurality of electronic payment transactions, generate a node embedding for each node of the graph data structure by: converting the transaction data associated with the node to first text, converting the external data associated with the node to second text, and generating the node embedding based on the first text and the second text.

### CROSS REFERENCE TO RELATED APPLICATION

This application claims the benefit of U.S. Provisional Patent Application No. 63/598,605, filed on Nov. 14, 2023, the disclosure of which is hereby incorporated by reference in its entirety.

### BACKGROUND

### 1. Field

This disclosure relates generally to transaction authorization and, in some non-limiting embodiments or aspects, to systems, methods, and computer program products for graph-based authorization.

### 2. Technical Considerations

With payment transactions in an electronic payment processing network, merchants are usually in a net positive settlement position, as they are paid by their acquirer for cleared and settled transactions. However, in certain scenarios, merchants can be in a net negative settlement position, resulting in the merchant paying their acquirer. This may happen if the merchant experiences a sudden spike of “reverse flow” transactions, such as chargebacks or merchandise credits, that exceeds their purchase transaction volume. For example, due to Covid-19, transaction volumes at cruise lines substantially declined which impacted companies in the industry. Cruise lines were forced to cancel trips which led to a sudden rise in chargebacks from cardholders. And with no customer bookings to offset these chargebacks, a cruise line would be left in a net negative settlement position with their acquirer.

When a merchant is in a net negative settlement position, it poses substantial risks to acquirers and issuers and requires them, in addition to transaction processing systems, to expend unnecessary resources.

### SUMMARY

According to non-limiting embodiments or aspects, provided is a system comprising at least one processor programmed or configured to: process a plurality of electronic payment transactions for a plurality of merchant systems arranged in an electronic payment processing network; generate a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network; generate a node embedding for each node of the graph data structure by: converting the transaction data associated with the node to first text; converting the external data associated with the node to second text; and generating the node embedding based on the first text and the second text; determine that a merchant or group of merchants is associated with a negative settlement risk based on the graph data structure; and determine whether to authorize an electronic payment transaction based on the negative settlement risk.

In non-limiting embodiments or aspects, each of the plurality of nodes correspond to at least one of the following: a merchant, an account holder, an issuer institution, an acquirer institution, an external data source, or any combination thereof. In non-limiting embodiments or aspects, determining that the merchant or group of merchants is associated with the negative settlement risk based on the graph data structure comprises: determining a risk score for each node of the plurality of nodes; propagating the risk score for each node to at least one other node via at least one edge of the plurality of edges; and determining that a risk score for a merchant node satisfies a threshold. In non-limiting embodiments or aspects, the plurality of edges comprise a plurality of direct edges connecting nodes involved in at least one transaction, and a plurality of soft edges connecting nodes associated within the external data. In non-limiting embodiments or aspects, the graph data structure comprises a graph neural network. In non-limiting embodiments or aspects, the at least one processor is further programmed or configured to: receive a new payment transaction associated with at least one node of the graph data structure; convert transaction data for the new payment transaction to new text; and concatenate the new text to existing text associated with a node embedding of the at least one node. In non-limiting embodiments or aspects, the at least one processor is further programmed or configured to: detect an anomaly in a node or node cluster of the plurality of nodes; and predict an insolvency event based on the anomaly.

According to non-limiting embodiments or aspects, provided is a method comprising: processing a plurality of electronic payment transactions for a plurality of merchant systems arranged in an electronic payment processing network; generating a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network; generating a node embedding for each node of the graph data structure by: converting the transaction data associated with the node to first text; converting the external data associated with the node to second text; and generating the node embedding based on the first text and the second text; determining that a merchant or group of merchants is associated with a negative settlement risk based on the graph data structure; and determining whether to authorize an electronic payment transaction based on the negative settlement risk.

In non-limiting embodiments or aspects, wherein each of the plurality of nodes correspond to at least one of the following: a merchant, an account holder, an issuer institution, an acquirer institution, an external data source, or any combination thereof. In non-limiting embodiments or aspects, wherein determining that the merchant or group of merchants is associated with the negative settlement risk based on the graph data structure comprises: determining a risk score for each node of the plurality of nodes; propagating the risk score for each node to at least one other node via at least one edge of the plurality of edges; and determining that a risk score for a merchant node satisfies a threshold. In non-limiting embodiments or aspects, the plurality of edges comprise a plurality of direct edges connecting nodes involved in at least one transaction, and a plurality of soft edges connecting nodes associated within the external data. In non-limiting embodiments or aspects, the graph data structure comprises a graph neural network. In non-limiting embodiments or aspects, further comprising: receiving a new payment transaction associated with at least one node of the graph data structure; converting transaction data for the new payment transaction to new text; and concatenating the new text to existing text associated with a node embedding of the at least one node. In non-limiting embodiments or aspects, further comprising: detecting an anomaly in a node or node cluster of the plurality of nodes; and predicting an insolvency event based on the anomaly.

According to non-limiting embodiments or aspects, provided is a computer program product comprising at least one non-transitory medium including program instructions that, when executed by at least one processor, cause the at least one processor to: process a plurality of electronic payment transactions for a plurality of merchant systems arranged in an electronic payment processing network; generate a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network; generate a node embedding for each node of the graph data structure by: converting the transaction data associated with the node to first text; converting the external data associated with the node to second text; and generating the node embedding based on the first text and the second text; determine that a merchant or group of merchants is associated with a negative settlement risk based on the graph data structure; and determine whether to authorize an electronic payment transaction based on the negative settlement risk.

In non-limiting embodiments or aspects, wherein each of the plurality of nodes correspond to at least one of the following: a merchant, an account holder, an issuer institution, an acquirer institution, an external data source, or any combination thereof. In non-limiting embodiments or aspects, wherein determining that the merchant or group of merchants is associated with the negative settlement risk based on the graph data structure comprises: determining a risk score for each node of the plurality of nodes; propagating the risk score for each node to at least one other node via at least one edge of the plurality of edges; and determining that a risk score for a merchant node satisfies a threshold. In non-limiting embodiments or aspects, the plurality of edges comprise a plurality of direct edges connecting nodes involved in at least one transaction, and a plurality of soft edges connecting nodes associated within the external data. In non-limiting embodiments or aspects, the graph data structure comprises a graph neural network. In non-limiting embodiments or aspects, the at least one processor is further caused to: receive a new payment transaction associated with at least one node of the graph data structure; convert transaction data for the new payment transaction to new text; and concatenate the new text to existing text associated with a node embedding of the at least one node. In non-limiting embodiments or aspects, the at least one processor is further caused to: detect an anomaly in a node or node cluster of the plurality of nodes; and predict an insolvency event based on the anomaly.

Other non-limiting embodiments or aspects will be set forth in the following numbered clauses:

Clause 1: A system comprising at least one processor programmed or configured to: process a plurality of electronic payment transactions for a plurality of merchant systems arranged in an electronic payment processing network; generate a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network; generate a node embedding for each node of the graph data structure by: converting the transaction data associated with the node to first text; converting the external data associated with the node to second text; and generating the node embedding based on the first text and the second text; determine that a merchant or group of merchants is associated with a negative settlement risk based on the graph data structure; and determine whether to authorize an electronic payment transaction based on the negative settlement risk.

Clause 2: The system of clause 1, wherein each of the plurality of nodes correspond to at least one of the following: a merchant, an account holder, an issuer institution, an acquirer institution, an external data source, or any combination thereof.

Clause 3: The system of clause 1 or 2, wherein determining that the merchant or group of merchants is associated with the negative settlement risk based on the graph data structure comprises: determining a risk score for each node of the plurality of nodes; propagating the risk score for each node to at least one other node via at least one edge of the plurality of edges; and determining that a risk score for a merchant node satisfies a threshold.

Clause 4: The system of any of clauses 1-3, wherein the plurality of edges comprise a plurality of direct edges connecting nodes involved in at least one transaction, and a plurality of soft edges connecting nodes associated within the external data.

Clause 5: The system of any of clauses 1-4, wherein the graph data structure comprises a graph neural network.

Clause 6: The system of any of clauses 1-5, wherein the at least one processor is further programmed or configured to: receive a new payment transaction associated with at least one node of the graph data structure; convert transaction data for the new payment transaction to new text; and concatenate the new text to existing text associated with a node embedding of the at least one node.

Clause 7: The system of any of clauses 1-6, wherein the at least one processor is further programmed or configured to: detect an anomaly in a node or node cluster of the plurality of nodes; and predict an insolvency event based on the anomaly.

Clause 8: A method comprising: processing a plurality of electronic payment transactions for a plurality of merchant systems arranged in an electronic payment processing network; generating a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network; generating a node embedding for each node of the graph data structure by: converting the transaction data associated with the node to first text; converting the external data associated with the node to second text; and generating the node embedding based on the first text and the second text; determining that a merchant or group of merchants is associated with a negative settlement risk based on the graph data structure; and determining whether to authorize an electronic payment transaction based on the negative settlement risk.

Clause 9: The method of clause 8, wherein each of the plurality of nodes correspond to at least one of the following: a merchant, an account holder, an issuer institution, an acquirer institution, an external data source, or any combination thereof.

Clause 10: The method of clause 8 or 9, wherein determining that the merchant or group of merchants is associated with the negative settlement risk based on the graph data structure comprises: determining a risk score for each node of the plurality of nodes; propagating the risk score for each node to at least one other node via at least one edge of the plurality of edges; and determining that a risk score for a merchant node satisfies a threshold.

Clause 11: The method of any of clauses 8-10, wherein the plurality of edges comprise a plurality of direct edges connecting nodes involved in at least one transaction, and a plurality of soft edges connecting nodes associated within the external data.

Clause 12: The method of any of clauses 8-11, wherein the graph data structure comprises a graph neural network.

Clause 13: The method of any of clauses 8-12, further comprising: receiving a new payment transaction associated with at least one node of the graph data structure; converting transaction data for the new payment transaction to new text; and concatenating the new text to existing text associated with a node embedding of the at least one node.

Clause 14: The method of any of clauses 8-13, further comprising: detecting an anomaly in a node or node cluster of the plurality of nodes; and predicting an insolvency event based on the anomaly.

Clause 15: A computer program product comprising at least one non-transitory medium including program instructions that, when executed by at least one processor, cause the at least one processor to: process a plurality of electronic payment transactions for a plurality of merchant systems arranged in an electronic payment processing network; generate a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network; generate a node embedding for each node of the graph data structure by: converting the transaction data associated with the node to first text; converting the external data associated with the node to second text; and generating the node embedding based on the first text and the second text; determine that a merchant or group of merchants is associated with a negative settlement risk based on the graph data structure; and determine whether to authorize an electronic payment transaction based on the negative settlement risk.

Clause 16: The computer program product of clause 15, wherein each of the plurality of nodes correspond to at least one of the following: a merchant, an account holder, an issuer institution, an acquirer institution, an external data source, or any combination thereof.

Clause 17: The computer program product of clause 15 or 16, wherein determining that the merchant or group of merchants is associated with the negative settlement risk based on the graph data structure comprises: determining a risk score for each node of the plurality of nodes; propagating the risk score for each node to at least one other node via at least one edge of the plurality of edges; and determining that a risk score for a merchant node satisfies a threshold.

Clause 18: The computer program product of any of clauses 15-17, wherein the plurality of edges comprise a plurality of direct edges connecting nodes involved in at least one transaction, and a plurality of soft edges connecting nodes associated within the external data.

Clause 19: The computer program product of any of clauses 15-18, wherein the graph data structure comprises a graph neural network.

Clause 20: The computer program product of any of clauses 15-19, wherein the at least one processor is further caused to: receive a new payment transaction associated with at least one node of the graph data structure; convert transaction data for the new payment transaction to new text; and concatenate the new text to existing text associated with a node embedding of the at least one node.

Clause 21: The computer program product of any of clauses 15-20, wherein the at least one processor is further caused to: detect an anomaly in a node or node cluster of the plurality of nodes; and predict an insolvency event based on the anomaly.

These and other features and characteristics of the present disclosure, as well as the methods of operation and functions of the related elements of structures and the combination of parts and economies of manufacture, will become more apparent upon consideration of the following description and the appended claims with reference to the accompanying drawings and appendices, all of which form a part of this specification, wherein like reference numerals designate corresponding parts in the various figures. It is to be expressly understood, however, that the drawings and appendix are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for graph-based authorization according to some non-limiting embodiments or aspects;

FIG. 2 is a flow diagram of a method for graph-based authorization according to some non-limiting embodiments or aspects;

FIG. 3 is a data structure used with a system for graph-based authorization according to some non-limiting embodiments or aspects;

FIG. 4 is another schematic diagram of a system for graph-based authorization according to some non-limiting embodiments or aspects;

FIG. 5 is a graph used with a system for graph-based authorization according to some non-limiting embodiments or aspects;

FIG. 6 is a schematic diagram of example components of one or more devices according to some non-limiting embodiments or aspects; and

FIG. 7 is a schematic diagram of an electronic payment processing network used in connection with some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments described herein allow for electronic payment transactions to be authorized in an efficient and improved manner. For example, non-limiting embodiments reduce the computational resources (e.g., processing and network resources) associated with processing chargebacks and unsuccessful transactions. Moreover, non-limiting embodiments provide for an enhanced and improved graph neural network (GNN) with improved embeddings that provide for more accurate and efficient results. Moreover, non-limiting embodiments may enable acquirer systems to avoid settling on behalf of a merchant and therefore avoid the associated computational processing tasks as well as financial loss. Those skilled in the art will appreciate other benefits, advantages, and improvements are provided by non-limiting embodiments described herein.

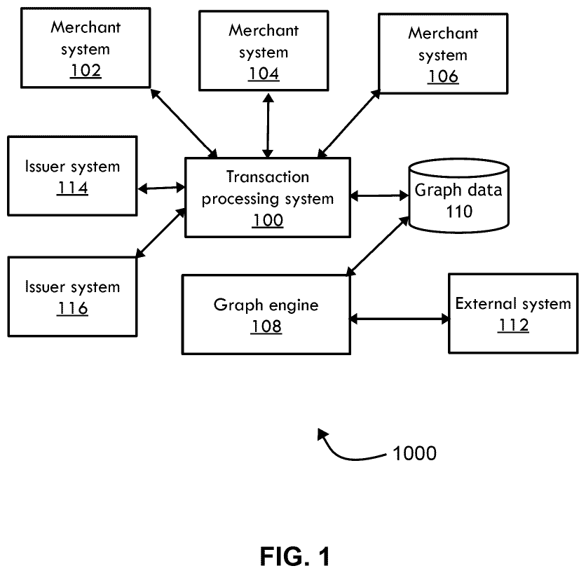

Referring to FIG. 1, a system 1000 for graph-based authorization is shown according to non-limiting embodiments or aspects. The system 1000 may be configured to determine whether to authorize or decline an electronic payment transaction based on a predicted settlement position. The system 1000 may include a graph engine 108, which may include one or more software applications and/or computing devices executing one or more software applications. The system also includes a transaction processing system 100 arranged in an electronic payment processing network. In non-limiting embodiments, the graph engine 108 may be part of (e.g., integrated with) the transaction processing system, although the graph engine 108 may also be a separate system in some non-limiting embodiments. The transaction processing system 100 is in communication with a plurality of merchant systems 102, 104, 106 that generate and communicate transaction requests for payment transactions initiated through the merchant. Any number of merchant systems may be in communication with the transaction processing system 100. In some examples, a payment gateway and/or acquirer system (not shown in FIG. 1) may facilitate communication between the merchant systems 102, 104, 106 and the transaction processing system 100.

With continued reference to FIG. 1, the transaction processing system 100 is also in communication with a plurality of issuer systems 114, 116 for settling the payment transactions requested by the merchant systems 102, 104, 106. It will be appreciated that one or more issuer systems may be in communication with the transaction processing system 100. In some examples the transaction processing system 100 may also serve as an issuer system. The graph engine 108 and/or transaction processing system 100 may be in communication with one or more external systems 112, which may include informational databases, news sources, stock tickers/databases, web search engines, and/or the like. The graph engine 108 and/or transaction processing system 100 may be in communication with the external system(s) 112 via one or more APIs and/or other like interfaces. In some examples information may be obtained from or provided by the external system(s) 112 at periodic intervals and/or continually.

Still referring to FIG. 1, the graph engine 108 and/or transaction processing system 100 are in communication with a graph database 110 that includes graph data, such as one or more graph data structures, GNNs, and/or the like. In non-limiting embodiments, the graph engine 108 and/or transaction processing system 100 store transaction data in a knowledge graph within the graph database 110. The graph database 110 may be supported by any data storage device. The graph database 110 may be a separate database or may be part of a transaction database or other like database.

In non-limiting embodiments, a graph data structure is generated by the graph engine 108 based on transaction data resulting from processing payment transactions and external data (e.g., from the external system(s) 112). Transaction data may include, for example, transaction value, transaction data, merchant identifier, merchant category code, account identifier, account holder information, and/or the like information for each transaction of a plurality of transactions between two entities (e.g., account holders, merchants, banks, and/or the like). The graph data structure may include a plurality of nodes connected with a plurality of edges. The nodes may represent merchants, account holders, issuer systems, acquirer systems, external data sources, and/or the like. The edges may represent transactions between the nodes, such as merchant-to-merchant transactions, transactions between account holders and merchants, and other interactions by the systems and/or entities represented by the nodes. In non-limiting embodiments, the edges may also represent relationships between external data and/or external data sources and entity nodes.

In non-limiting embodiments, each node may have a classification (e.g., type), such as a merchant node, an account holder node, a bank node (e.g., an issuer node or an acquirer node), a merchant category node (e.g., representing multiple merchants that are in the same Merchant Category Code (MCC) or the like), a geographic node (e.g., representing entities in a geographic area), an event node, an external data node, and/or the like. In non-limiting embodiments, each edge may have a classification (e.g., type), such as an account holder to merchant edge (which may have subclassifications of purchases, returns, chargebacks, and/or the like), an account holder to account holder edge (e.g., such as a peer-to-peer payment), a bank to bank edge (which may have subclassifications of settlement, Bank Identification Number (BIN) sponsorship, and/or the like), a merchant parent/subsidiary relationship edge, a merchant to merchant edge, an industry to industry edge, and/or the like. It will be appreciated that indirect edges may also be created between entity nodes and nodes representing external data and/or external data sources.

In non-limiting embodiments, the graph engine 108 and/or another system may generate node embeddings for the nodes in the graph data structure. A node embedding may include transaction data associated with the node (e.g., for a merchant node, transaction data for all transactions processed by the merchant and/or the like) and/or external data about the merchant and/or an industry (e.g., merchant category and/or the like) of the merchant. The embeddings may be generated by converting the transaction data to text (e.g., a textual description, such as a narrative or summary) and converting the external data to text (e.g., a textual description, such as a narrative or summary). In some examples, additional transactions may be included by concatenating the textual data for the transactions with an existing string for the node embedding. In this manner, the nodes for entities may be periodically and/or continually updated.

In non-limiting embodiments, the graph engine 108 and/or another system may generate node embeddings by generating text for the transaction data (e.g., edges connected to the node) and/or text from one or more external systems. For example, the transaction data represented by the edges connected to a node may be converted into a first textual description (e.g., narrative, summary, and/or the like). The conversion of data to text may be performed with one or more rules for processing formatted transaction data and generating a description. In non-limiting embodiments, a Large Language Model (LLM) may be used to generate text from transaction data. The external data based on the node (e.g., entity) may be converted into a second textual description or summary in the same manner. The first text and the second text may then be converted into one or more features (e.g., such as a vector, tensor, and/or the like). In some non-limiting examples, the first text and second text may be combined before creating a feature. In some non-limiting examples, the first text and the second text may be used to create separate features that may be combined. The feature(s) may be used as the node embedding.

The graph data structure, once created, may be used by any entity (e.g., including entities within the electronic payment processing network) to assess a risk level for a merchant, bank, account holder, and/or the like. For example, the graph data structure may be used to form and/or train a GNN configured to output a predicted risk score for an input of transaction data for a transaction. The graph data structure may be used to predict that a merchant or group of merchants (e.g., clusters of merchants or merchants in a similar industry/category) is likely to be associated with a negative settlement position. A negative settlement position occurs when transactions are not settled and/or finalized by an acquirer system associated with the merchant, such that the merchant's obligations from transactions exceed the amount of cleared and settled transactions, or where the acquirer system must settle on the merchant's behalf because the merchant is unable to satisfy its obligations. Such risk determinations may be used to block transactions for certain merchants and/or groups of merchants (e.g., clusters of merchants or merchants in a similar industry/category).

In non-limiting embodiments, the graph data structure generated by the graph engine 108 may be used to determine that a merchant or a group of merchants is associated with a negative settlement risk. For example, a transaction processing system, acquirer system, issuer system, payment gateway, and/or other entity may determine that a group of merchants or a merchant is associated with a negative settlement risk and determine whether to take an action (e.g., whether to authorize an electronic payment transaction by an issuer system, whether to settle on behalf of a merchant by an acquirer system, and/or the like). The graph may be used to train a model that is queried through an API or other like interface.

In non-limiting embodiments, external data and/or external data sources may be represented by nodes. In such examples, in addition to or instead of creating an embedding for an entity node based on external data, the external data may be represented by a node and a node embedding generated based on the content of the external data (e.g., title/heading and body for an article, etc.). The relationship between entity nodes and external data nodes may be represented by edges (e.g., which may be soft edges as discussed herein) connecting the nodes.

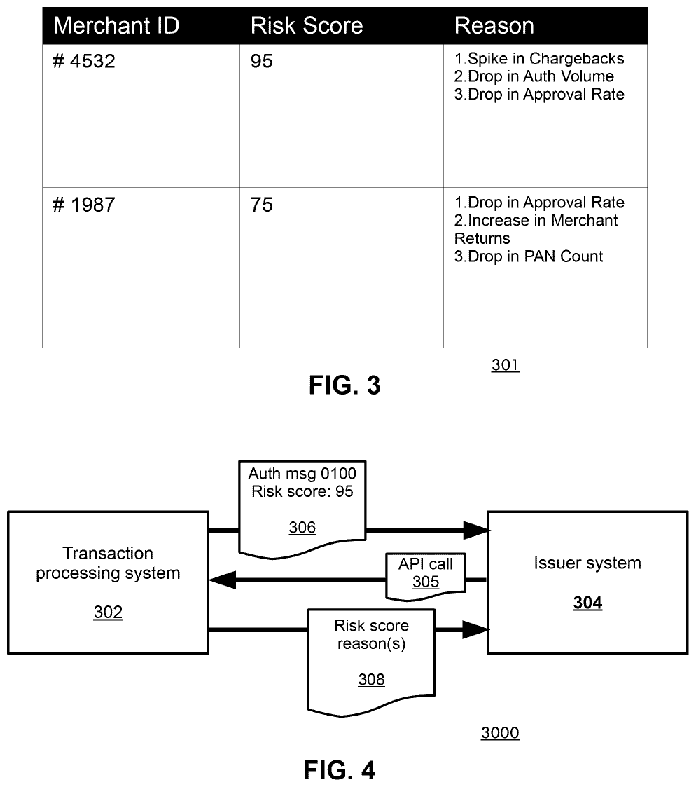

Referring now to FIG. 3, a model output 301 is shown according to non-limiting embodiments. This includes risk scores for each merchant and reasons for the risk score. The score may be attached and/or included to authorization messages provided to issuer systems and/or other systems to facilitate authorization determinations. The remainder of the data structure may be stored in memory such that it is retrievable by an issuer system or another party upon request.

FIG. 4 shows a system 3000 for graph-based authorization according to non-limiting embodiments or aspects. A transaction processing system 302 communicates an authorization message 306 (e.g., such as an authorization request message) to an issuer system 304. The authorization message 306 includes a risk score (e.g., 95) associated with the transaction. The risk score may be included in a field in the authorization message 306 and/or be attached to the authorization message 306. The issuer system 304 may use the score to make an authorization decision. In the event that the issuer system 304 seeks additional information, such as the reason(s) for the risk score having its value, the issuer system 304 may communicate a request 305 (e.g., via an API call or the like) to the transaction processing system 302 or another system. In response to the request, the transaction processing system 302 or another system may return one or more reasons (e.g., as shown in the data structure 308 of FIG. 3).

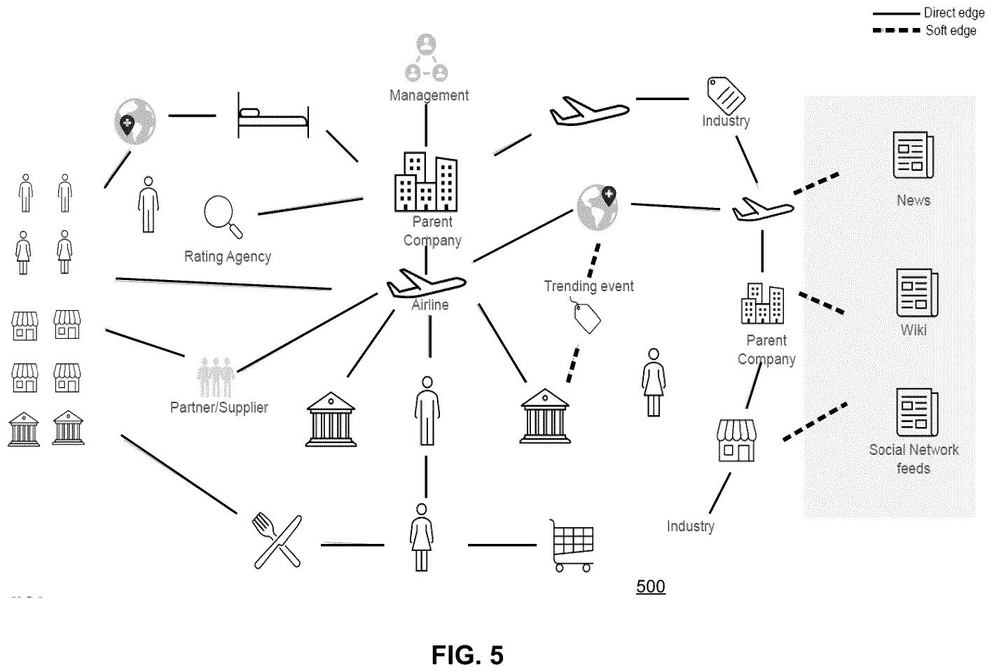

FIG. 5 shows an example graph 500 according to non-limiting embodiments. The graph 500 may be a knowledge graph with direct edges and indirect (e.g., soft) edges. A direct edge may connect two transacting nodes (e.g., such as entity nodes or the like) and an indirect (e.g., soft) node may connect a transacting node and a non-transacting node (e.g., such as an external data node). In non-limiting embodiments, edges may be assigned weights. An edge eᵢⱼ connects node i and j. A direct edge may represent transactions that connect cardholders, merchants, banks, and/or other entities, and may have a base weight of w_{b}=1. A soft edge may represent non-transactional interactions, such as external data mentioning and/or communicated to an entity (e.g., bank, merchant, and/or the like). Each soft edge may have a base weight of w_{b} between 0 and 1 that equals the similarity measure of the nodes connected (e.g., news and entity names). Each node/may maintain a count edge of cᵢ. When a message is passed between nodes, an edge may have the following carry weights: a weight of wᵢⱼ=w_{b}/cᵢ for direction i→j, and a weight of wⱼᵢ=w_{b}/cⱼ for direction j→i. When new edges are added to the graph, an edge count cᵢ may be incremented before the weight is updated.

In non-limiting embodiments, a similarity measure between nodes may be determined to connect external data with entity nodes. The similarity measure may be used to determine a weight of an edge connecting the two nodes. For example, for a node representing an external data source or external data (e.g., a news article), Name Entity Recognition (NER) may be performed on both the title and the body of the paper. An entity is determined from the external data source. A pairwise similarity (e.g., fuzzy matching) process may then be performed between an entity named in the external data source (e.g., the result of an extraction process to identify a primary entity from the source) and one or more existing entity names represented by entity nodes (e.g., internal entities), such as entities already identified within the transaction data. The entity name with the highest similarity may be identified as the main (e.g., primary) entity associated with that data source. If the similarity does not satisfy a threshold, a null value and/or other indication may be returned.

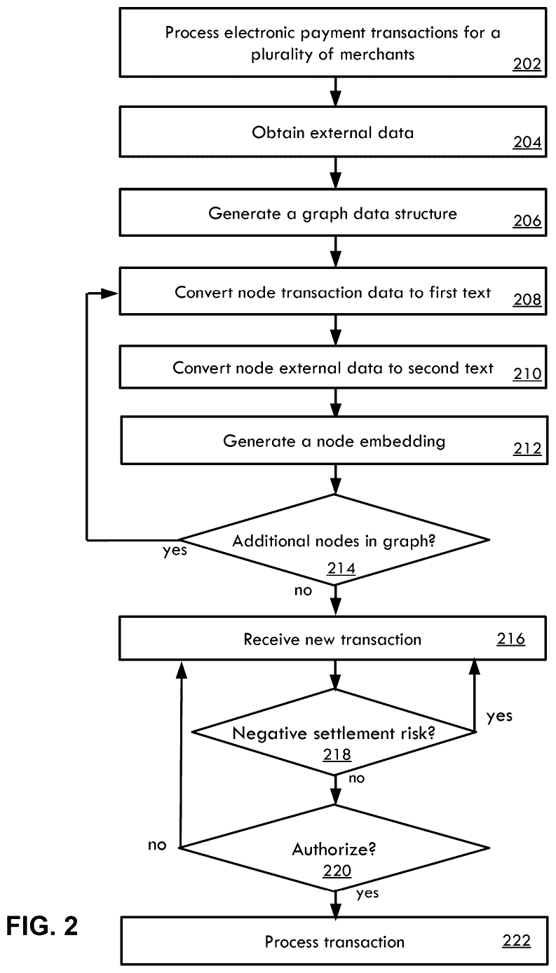

Referring now to FIG. 2, shown is a flow diagram for a method for graph-based authorization according to some non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. The steps shown in FIG. 2 may be performed by a transaction processing system and/or one or more other systems with access to transaction data.

At step 202, a plurality of electronic payment transactions are processed for a plurality of merchants. This may occur over any time period and may continually and/or periodically occur. For example, in some non-limiting embodiments, step 202 may be performed concurrently with the other steps to generate more transaction data that can be utilized in a new and/or modified graph data structure. At step 204, external data is obtained from one or more external sources (e.g., news sources, Internet search engines, social media, and/or the like). The external data may be obtained with queries generated based on a merchant, account holder, purchase category, and/or the like. In some examples the external data may include a predetermined set of articles and/or other data that is provided to and/or obtained by a transaction processing system, graph engine, and/or the like.

At step 206, a graph data structure is generated based on the transaction data and external data. Each node in the graph may represent one or more entities. For example, nodes may represent merchants, account holders, banks (e.g., issuer systems, acquirer systems, and/or the like), payment gateways, and/or other like entities. Nodes may also represent categories, such as merchant category (e.g., an MCC or the like), geographic categories (e.g., areas, regions, cities, countries, and/or the like), and o/r the like. The edges connecting the nodes may represent transactions between the entities and/or categories. For example, each edge may have a classification (e.g., type), such as an account holder to merchant edge (which may have subclassifications of purchases, returns, chargebacks, and/or the like), an account holder to account holder edge (e.g., such as a peer-to-peer payment), a bank to bank edge (which may have subclassifications of settlement, a BIN sponsorship, and/or the like), a merchant parent/subsidiary relationship edge, a merchant to merchant edge, an industry to industry edge, and/or the like.

Each node may include and/or be associated with transaction data and external data. For example, external data received or obtained at step 204 may be represented by nodes and/or be associated with one or more nodes. External data that mentions an entity, for example, may be associated with a corresponding entity node. Accordingly, each node is associated with transaction data and/or external data. At step 208, the transaction data for a node is converted to first text, such as a textual description (e.g., a textual narrative, summary, and/or the like). This may be performed using rules and/or a machine-learning model, such as but not limited to an LLM. As an example, a predefined template may be used to convert tabular transactional data to text description. As an example, transaction data may identify an account number and/or credentials, Bank ABC, the United Kingdom (UK), an amount (e.g., $80), a date and/or time (e.g., Feb. 4, 2022), and/or other transaction data. The resulting first text may be as follows: “The transaction is made Feb. 4, 2022 xx: xx: xx, worth $80 USD, type is e-commerce, cross-border, merchant is xyz2635, with acquiring bank ABC, Issuing bank XYZ, local currency Euro, and the credential provided is zip 64398, Expdt 11/25, CVV 263.”

At step 210, the external data associated with the node and/or entity is converted to second text, such as a textual description (e.g., a textual narrative, summary, and/or the like). This conversion may be performed using rules and/or a machine-learning model, such as but not limited to an LLM.

At step 212, a node embedding is generated for each node based on the first text and/or the second text. For example, each text may be individually converted into a feature and the node may be represented by two or more features. As another example, the first text and the second text may be combined (e.g., concatenated) and the resulting textual string may be converted into a feature (e.g., a vector, a tensor, and/or the like). It will be appreciated that one or more embeddings may be generated based on the textual data from steps 208 and 210 in various ways. The node embedding(s) may be generated by an LLM or other model and/or algorithm.

At step 214, it is determined if there are additional nodes to generate embeddings for. If there are additional nodes in the graph, the method may return to step 208 to process the next node until all nodes of the graph are represented by embeddings. At step 216, a new transaction (e.g., a transaction that was not used to generate the graph in step 206) is received. The new transaction may be received by a transaction processing system from a merchant system and/or payment gateway, as an example. In some examples, the new transaction may be associated with a request to process the transaction and/or a request to determine a risk associated with the transaction. For example, an issuer system that receives an authorization request from a transaction processing system may query the transaction processing system and/or another system for a risk score and/or risk determination.

At step 218, it is determined if the transaction is associated with a negative settlement risk. Determining if the transaction is associated with a negative settlement risk may include processing transaction data associated with the transaction (e.g., transaction value, transaction data, merchant identifier, MCC, account identifier, account holder information, and/or the like) with the graph to determine a negative settlement risk score. The risk score may be compared to one or more thresholds to determine if it satisfies the threshold (e.g., meet or exceed a threshold) and, if it satisfies the threshold, determine that the settlement risk is negative. At step 220 it is determined whether to authorize the transaction. Authorization may be determined based on whether the risk score satisfies a threshold and/or indicates a negative settlement risk. At step 222, the transaction is processed if it is authorized.

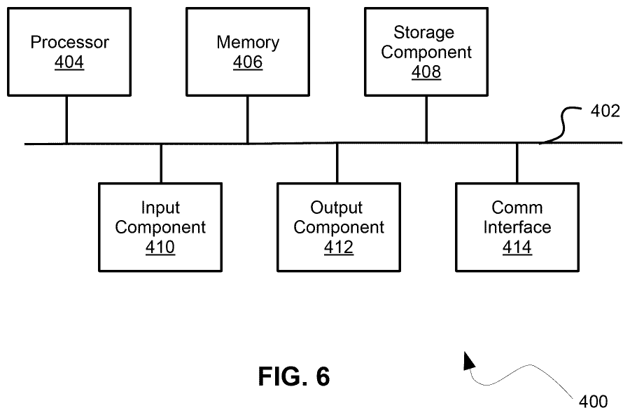

Referring now to FIG. 6, shown is a diagram of example components of a device 400 according to non-limiting embodiments or aspects. Device 400 may correspond to at least one of the computing devices (e.g., the graph engine 108, the transaction processing system 100, the merchant systems 102, 104, 106, the issuer system(s) 114, 116, the external system 112, etc.) in FIG. 1. In some non-limiting embodiments or aspects, such systems or devices may include at least one device 400 and/or at least one component of device 400. The number and arrangement of components shown in FIG. 6 are provided as an example. In some non-limiting embodiments or aspects, device 400 may include additional components, fewer components, different components, or differently arranged components than those shown in FIG. 6. Additionally, or alternatively, a set of components (e.g., one or more components) of device 400 may perform one or more functions described as being performed by another set of components of device 400.

As shown in FIG. 6, device 400 may include bus 402, processor 404, memory 406, storage component 408, input component 410, output component 412, and communication interface 414. Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 6, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

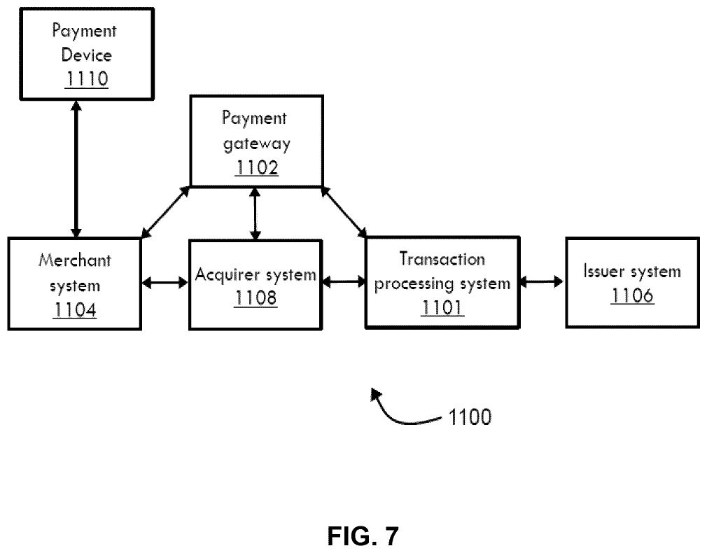

FIG. 7 shows an electronic payment processing network 1100 according to non-limiting embodiments or aspects. The payment processing network may be used in conjunction with the systems and methods described herein. It will be appreciated that the particular arrangement of the electronic payment processing network 1100 shown is for example purposes only, and that various arrangements are possible. A transaction processing system 1101 (e.g., a transaction handler) is shown to be in communication with one or more issuer systems (e.g., such as an issuer system 1106) and one or more acquirer systems (e.g., such as an acquirer system 1108). Although only a single issuer system 1106 and single acquirer system 1108 are shown, it will be appreciated that the transaction processing system 1101 may be in communication with a plurality of issuer systems and/or acquirer systems. In some embodiments, the transaction processing system 1101 may also operate as an issuer system such that both the transaction processing system 1101 and issuer system 1106 are a single system and/or controlled by a single entity.

In some non-limiting embodiments or aspects, the transaction processing system 1101 may communicate with a merchant system 1104 directly through a public or private network connection. Additionally or alternatively, the transaction processing system 1101 may communicate with the merchant system 1104 through a payment gateway 1102 and/or acquirer system 1108. In some non-limiting embodiments or aspects, an acquirer system 1108 associated with the merchant system 1104 may operate as the payment gateway 1102 to facilitate the communication of transaction requests from the merchant system 1104 to the transaction processing system 1101. The merchant system 1104 may communicate with the payment gateway 1102 through a public or private network connection. For example, a merchant system 1104 that includes a physical POS device may communicate with the payment gateway 1102 through a public or private network to conduct card-present transactions. As another example, a merchant system 1104 that includes a server (e.g., a web server) may communicate with the payment gateway 1102 through a public or private network, such as a public Internet connection, to conduct card-not-present transactions.

In some non-limiting embodiments or aspects, the transaction processing system 1101, after receiving a transaction request from the merchant system 1104 that identifies an account identifier of a payor (e.g., such as an account holder) associated with an issued payment device 1110, may generate an authorization request message to be communicated to the issuer system 1106 that issued the payment device 1110 and/or account identifier. The issuer system 1106 may then approve or decline the authorization request and, based on the approval or denial, generate an authorization response message that is communicated to the transaction processing system 1101. The transaction processing system 1101 may communicate an approval or denial to the merchant system 1104. When the issuer system 1106 approves the authorization request message, it may then clear and settle the payment transaction between the issuer system 1106 and acquirer system 1108.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising at least one processor programmed or configured to:
process a plurality of electronic payment transactions for a plurality of merchant systems arranged in an electronic payment processing network;
generate a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network;
generate a node embedding for each node of the graph data structure by:
converting the transaction data associated with the node to first text;
converting the external data associated with the node to second text; and
generating the node embedding based on the first text and the second text;
determine that a merchant or group of merchants is associated with a negative settlement risk based on the graph data structure; and
determine whether to authorize an electronic payment transaction based on the negative settlement risk.

2. The system of claim 1, wherein each of the plurality of nodes corresponds to at least one of the following: a merchant, an account holder, an issuer institution, an acquirer institution, an external data source, or any combination thereof.

3. The system of claim 1, wherein determining that the merchant or group of merchants is associated with the negative settlement risk based on the graph data structure comprises:
determining a risk score for each node of the plurality of nodes;
propagating the risk score for each node to at least one other node via at least one edge of the plurality of edges; and
determining that a risk score for a merchant node satisfies a threshold.

4. The system of claim 1, wherein the plurality of edges comprise a plurality of direct edges connecting nodes involved in at least one transaction, and a plurality of soft edges connecting nodes associated within the external data.

5. The system of claim 1, wherein the graph data structure comprises a graph neural network.

6. The system of claim 1, wherein the at least one processor is further programmed or configured to:
receive a new payment transaction associated with at least one node of the graph data structure;
convert transaction data for the new payment transaction to new text; and
concatenate the new text to existing text associated with a node embedding of the at least one node.

7. The system of claim 1, wherein the at least one processor is further programmed or configured to:
detect an anomaly in a node or node cluster of the plurality of nodes; and
predict an insolvency event based on the anomaly.

8. The system of claim 1, wherein the first text comprises a textual description or summary of the transaction data, and wherein the second text comprises a textual description or summary of the external data.

9. A method comprising:
processing a plurality of electronic payment transactions for a plurality of merchant systems arranged in an electronic payment processing network;
generating a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network;
generating a node embedding for each node of the graph data structure by:
converting the transaction data associated with the node to first text;
converting the external data associated with the node to second text; and
generating the node embedding based on the first text and the second text;
determining that a merchant or group of merchants is associated with a negative settlement risk based on the graph data structure; and
determining whether to authorize an electronic payment transaction based on the negative settlement risk.

10. The method of claim 9, wherein each of the plurality of nodes corresponds to at least one of the following: a merchant, an account holder, an issuer institution, an acquirer institution, an external data source, or any combination thereof.

11. The method of claim 9, wherein determining that the merchant or group of merchants is associated with the negative settlement risk based on the graph data structure comprises:
determining a risk score for each node of the plurality of nodes;
propagating the risk score for each node to at least one other node via at least one edge of the plurality of edges; and
determining that a risk score for a merchant node satisfies a threshold.

12. The method of claim 9, wherein the plurality of edges comprise a plurality of direct edges connecting nodes involved in at least one transaction, and a plurality of soft edges connecting nodes associated within the external data.

13. The method of claim 9, wherein the graph data structure comprises a graph neural network.

14. The method of claim 9, further comprising:
receiving a new payment transaction associated with at least one node of the graph data structure;
converting transaction data for the new payment transaction to new text; and
concatenating the new text to existing text associated with a node embedding of the at least one node.

15. The method of claim 9, further comprising:
detecting an anomaly in a node or node cluster of the plurality of nodes; and
predicting an insolvency event based on the anomaly.

16. The method of claim 9, wherein converting the transaction data associated with the node to the first text comprises generating a textual description or summary of the transaction data.

17. The method of claim 9, wherein converting the external data associated with the node to the second text comprises generating a textual description or summary of the external data.

18. A computer program product comprising at least one non-transitory medium including program instructions that, when executed by at least one processor, cause the at least one processor to:
process a plurality of electronic payment transactions for a plurality of merchant systems arranged in an electronic payment processing network;
generate a graph data structure comprising a plurality of nodes and a plurality of edges based on transaction data and external data, the transaction data comprising transaction parameters from each electronic payment transaction of the plurality of electronic payment transactions, the external data comprising information received from a system outside of the electronic payment processing network;
generate a node embedding for each node of the graph data structure by:
converting the transaction data associated with the node to first text;
converting the external data associated with the node to second text; and
generating the node embedding based on the first text and the second text;
determine that a merchant or group of merchants is associated with a negative settlement risk based on the graph data structure; and
determine whether to authorize an electronic payment transaction based on the negative settlement risk.

19. The computer program product of claim 18, wherein each of the plurality of nodes corresponds to at least one of the following: a merchant, an account holder, an issuer institution, an acquirer institution, an external data source, or any combination thereof.

20. The computer program product of claim 18, wherein determining that the merchant or group of merchants is associated with the negative settlement risk based on the graph data structure comprises:
determining a risk score for each node of the plurality of nodes;
propagating the risk score for each node to at least one other node via at least one edge of the plurality of edges; and
determining that a risk score for a merchant node satisfies a threshold.
